(19) United States
(12) Patent Application Publication
(10) Pub. No.: US 2017/0363206 A1
(43) Pub. Date: Dec. 21, 2017

(54) GEAR DRIVE ASSEMBLY HAVING ONE OF A FIRST SELECTED GEAR AND A SECOND SELECTED GEAR AND A METHOD OF PRODUCING THE SAME

(71) Applicant: BorgWarner Inc., Auburn Hills, MI (US)

(72) Inventors: Martin P. BOGEN, St. Clair Shores, MI (US); James SHARPE, South Lyon, MI (US)

(21) Appl. No.: 15/628,726

(22) Filed: Jun. 21, 2017

Related U.S. Application Data
(63) Continuation of application No. 62/352,697, filed on Jun. 21, 2016.

(51) Int. Cl. F16H 63/30; F16H 37/04; F16H 63/44; F16H 3/087; H02K 7/116

(52) U.S. Cl. CPC F16H 63/30; F16H 63/44; F16H 3/087; F16H 37/04; H02K 7/116

(57) ABSTRACT

A gear drive assembly is used in an actuator. The gear drive assembly includes a housing and a gear arrangement including a drive gear, a driven gear, and one of a first selected gear and a second selected gear engageable with both of the drive and driven gears. The drive and driven gears and the first selected gear have a first gear ratio. The drive and driven gears and the second selected gear have a second gear ratio not equal to the first gear ratio. The internal surface of the housing defines first and second gear retention features to facilitate selective rotatable coupling of the first and second selected gears with the housing, respectively. A method of manufacturing the gear drive assembly includes the steps of selecting one of the first and second selected gears, engaging it with the drive and driven gears, and coupling it with the housing.

### CROSS-REFERENCE TO RELATED APPLICATIONS

This application claims the benefit of U.S. patent application Ser. No. 62/352,697 filed on Jun. 21, 2016, the disclosure of which is herein incorporated by reference in its entirety.

### BACKGROUND OF THE INVENTION

### 1. Field of the Invention

A gear drive assembly for an actuator and a method of manufacturing the gear drive assembly.

### 2. Description of Related Art

Many fluid flow devices in vehicles, such as a turbochargers and exhaust gas recirculation (EGR) valves, use an actuator system to control their functions and performance. For example, in certain actuator systems, pneumatic and electric actuators are used to provide positional control of variable vanes of a turbocharger or a valve plate of an EGR valve to adjust and maintain fluid pressure and fluid flow within an intake manifold of an engine. Controlling the fluid pressure and the fluid flow within the intake manifold provides optimum performance while maintaining legislated vehicle emissions.

Traditionally, the actuator includes a gear drive assembly which transmits rotational motion to the fluid flow device. The gear drive assembly provides a plurality of gears which collectively interact to provide a velocity and a torque to the fluid flow device for moving the fluid flow device. The velocity and the torque needed to move the fluid flow device varies with different vehicle applications. As such, numerous gear drive assemblies must be produced, each having unique gear arrangements and unique housings to retain the gear arrangements, which requires additional tooling and manufacturing lines to produce. As such, there remains a need to provide an improved gear drive assembly.

### SUMMARY OF THE INVENTION AND ADVANTAGES

The subject invention provides for a gear drive assembly for use with and driven by a motor in an actuator, with the actuator capable of moving an output shaft between a plurality of positions. The actuator has one of a first output, having a first velocity and a first torque, and a second output, having a second velocity and a second torque. The gear drive assembly comprises a housing having an internal surface defining a cavity and a gear arrangement disposed in the cavity and comprising a drive gear, at least one driven gear, and one of a first selected gear and a second selected gear engageable with both of the drive and the at least one driven gears to transmit rotation from the drive gear to the at least one driven gear. The drive and the at least one driven gears are each rotatably coupled with the housing.

The drive and the at least one driven gears and the first selected gear have a first gear ratio for selectively moving the output shaft with the first output. The drive and the at least one driven gears and the second selected gear have a second gear ratio not equal to the first gear ratio for selectively moving the output shaft with the second output. The internal surface of the housing defines a first gear retention feature to facilitate selective rotatable coupling of the first selected gear with the housing, and a second gear retention feature to facilitate selective rotatable coupling of the second selected gear with the housing.

The subject invention further provides for a method of manufacturing a gear drive assembly for use with and driven by a motor in an actuator. The actuator is capable of moving an output shaft between a plurality of positions, with the actuator having one of a first output, having a first velocity and a first torque, and a second output, having a second velocity and a second torque. The gear drive assembly comprises a housing having an internal surface defining a cavity, and a gear arrangement disposed in the cavity and comprising a drive gear, at least one driven gear, and one of a first selected gear and a second selected gear. The drive and the at least one driven gears and the first selected gear have a first gear ratio for selectively moving the output shaft with the first output, and the drive and the at least one driven gears and the second selected gear have a second gear ratio not equal to the first gear ratio for selectively moving the output shaft with the second output.

The method comprises the steps of rotatably coupling the drive and the at least one driven gears with the housing within the cavity, selecting one of the first and second selected gears, engaging the one of the first and second selected gears with both of the drive and the at least one driven gears, and rotatably coupling the one of the first and second selected gears with the housing within the cavity.

Accordingly, the gear drive assembly allows for different properties (i.e., the first and second outputs) by selecting between the first and second selected gears. The housing is correspondingly designed to accommodate each of the first and second selected gears. As such, only one housing is needed to accommodate two different outputs. Because one housing is needed rather than two, manufacturing costs are reduced.

### BRIEF DESCRIPTION OF THE DRAWINGS

Advantages of the subject invention will be readily appreciated as the same becomes better understood by reference to the following detailed description when considered in connection with the accompanying drawings.

FIG. 1 is a schematic view of an actuator system used with an engine, an intake manifold, an exhaust manifold, and a turbocharger.

FIG. 2 is a side elevational view of an actuator of the actuator system, showing a motor and a gear drive assembly.

FIG. 3 is a perspective view of a valve for use with the actuator system.

FIG. 4 is a top elevational view of the actuator of the actuator system.

FIG. 5 is a cross-sectional view of the actuator taken along Section A-A shown in FIG. 4.

FIG. 6 is a bottom elevational view of the actuator, with a second section of a housing of the gear drive assembly removed and showing a first selected gear.

FIG. 7 is a bottom elevational view of the actuator, with the second section assembly removed and showing a second selected gear.

FIG. 8 is a bottom elevational view of the motor, a first section of the housing, at least one driven gear, and a second driven gear.

FIG. 9 is a top elevational view of the first section of the housing, a drive gear, at least one driven gear, and a second driven gear.

FIG. 10 is a perspective view of a gear drive assembly having a housing which has a first section, a second section, and a third section.

FIG. 11 is a bottom elevational view of the gear drive assembly shown in FIG. 10, with the second and third sections of the housing of the gear drive assembly removed and showing a first selected gear and a first selected first driven gear.

FIG. 12 is a bottom elevational view of the gear drive assembly shown in FIG. 10, with the second and third sections of the housing of the gear drive assembly removed and showing a second selected gear and a second selected first driven gear.

### DETAILED DESCRIPTION OF THE INVENTION

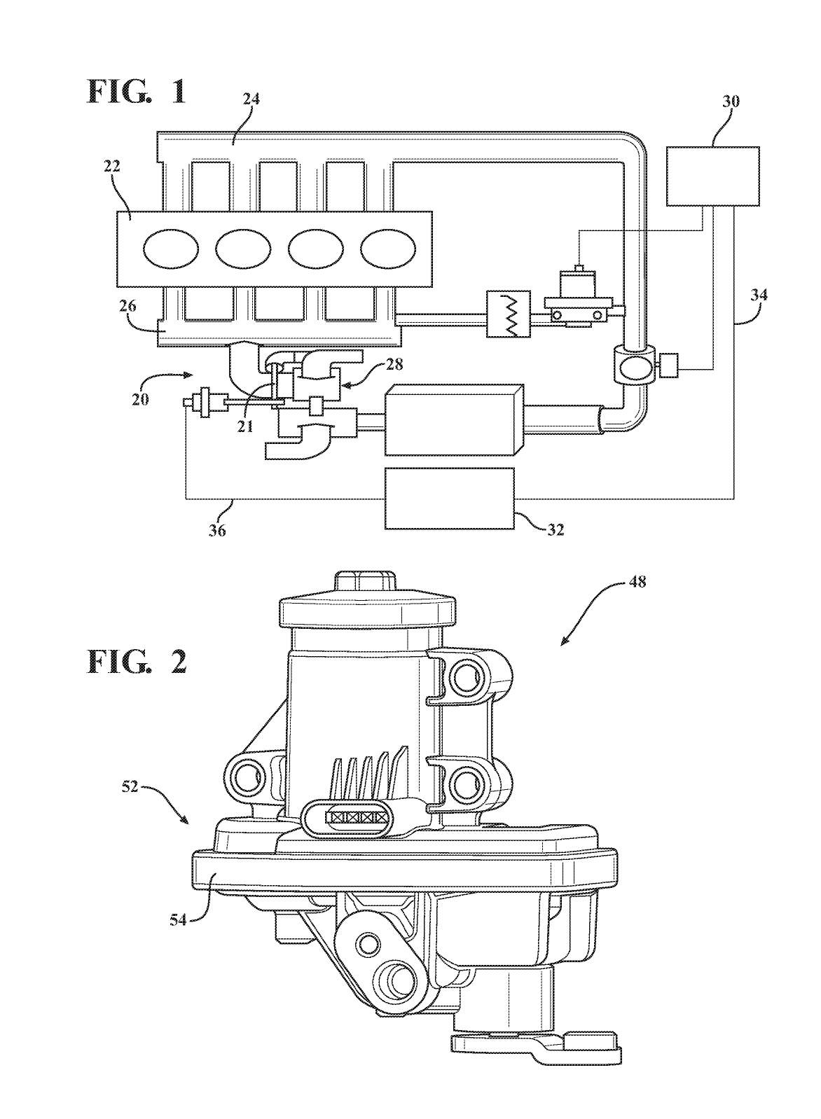

Referring to the Figures, wherein like numerals indicates like or corresponding parts throughout the several views, an actuator system 20 is generally shown in FIG. 1. The actuator system 20 is typically used for controlling a control shaft 21 within a vehicle. In one example, the control shaft 21 controls the flow of a fluid to or from an engine 22 of the vehicle. As shown schematically in FIG. 1, the vehicle may comprise the engine 22, an intake manifold 24 configured to flow air into the engine 22, and an exhaust manifold 26 configured to flow exhaust out of the engine 22. In one embodiment, the control shaft 21 is used in a turbocharger 28 which is fluidly coupled with each of the intake manifold 24 and the exhaust manifold 26 to increase flow of the air into the engine 22 by way of utilizing the energy of the moving exhaust flowing out of the engine 22, as is commonly known to those having ordinary skill in the art. The actuator system 20 is positioned between the exhaust manifold 26 and the turbocharger 28, with the actuator system 20 controlling a position of the turbocharger 28 (described in greater detail below) through the control shaft 21, which in-turn controls the pressure and the flow of the air into the engine 22 through the intake manifold 24 and is commonly referred to as boost pressure.

The vehicle may further comprise an electronic control unit (ECU) 30 and an actuator controller 32. The ECU 30 may be connected to the actuator controller 32 by a wire harness 34 having multiple conductors and connectors. The actuator controller 32 may also be connected to the actuator system 20 by a wire harness 36 having multiple conductors and connectors. For this illustration, the actuator controller 32 is shown as separate component. However, one having skill in the art will appreciate that the actuator controller 32 may be integrated within actuator system 20 or the ECU 30.

The ECU 30 may provide an electrical position input signal to the actuator controller 32 that may indicate a desired position of the control shaft 21 as controlled by the actuator system 20, as will be further understood through further description below. The actuator controller 32 may provide the necessary electrical control signal to the actuator system 20 to achieve the desired position of the control shaft 21.

The actuator system 20 may also provide feedback in the form of an electrical position output signal to the actuator controller 32. A “closed loop” control scheme may be used to maintain a desired position of the control shaft 21 as controlled by the actuator system 20 by comparing the feedback electrical position output signal value to a desired value and may adjust the electrical control signal to the actuator system 20 to maintain the resulting position of the control shaft 21 and the resultant fluid flow and boost pressure.

Although the actuator system 20 is shown in FIG. 1 controlling a position of the turbocharger 28, one having skill in the art will appreciate that the actuator system 20 may be used anywhere within automobiles for controlling the flow of a fluid to or from an engine, such as with an exhaust gas recirculation (EGR) valve or as a throttle fluidly coupled to an intake manifold 24.

The actuator system 20 comprises an output shaft 88, movable between a plurality of positions. The output shaft 88 may be coupled to the control shaft 21 of the turbocharger 28, as described above. The turbocharger 28 may comprise a turbine fluidly coupled with the exhaust manifold 26 and a compressor fluidly coupled with the intake manifold 24. The turbine may have a plurality of vanes. The movement of the control shaft 21 by the movement of the output shaft 88 may vary the orientation of the vanes to alter the flow of the fluid past the turbine, which in-turn alters the pressure and the flow of the fluid from the compressor into the intake manifold 24.

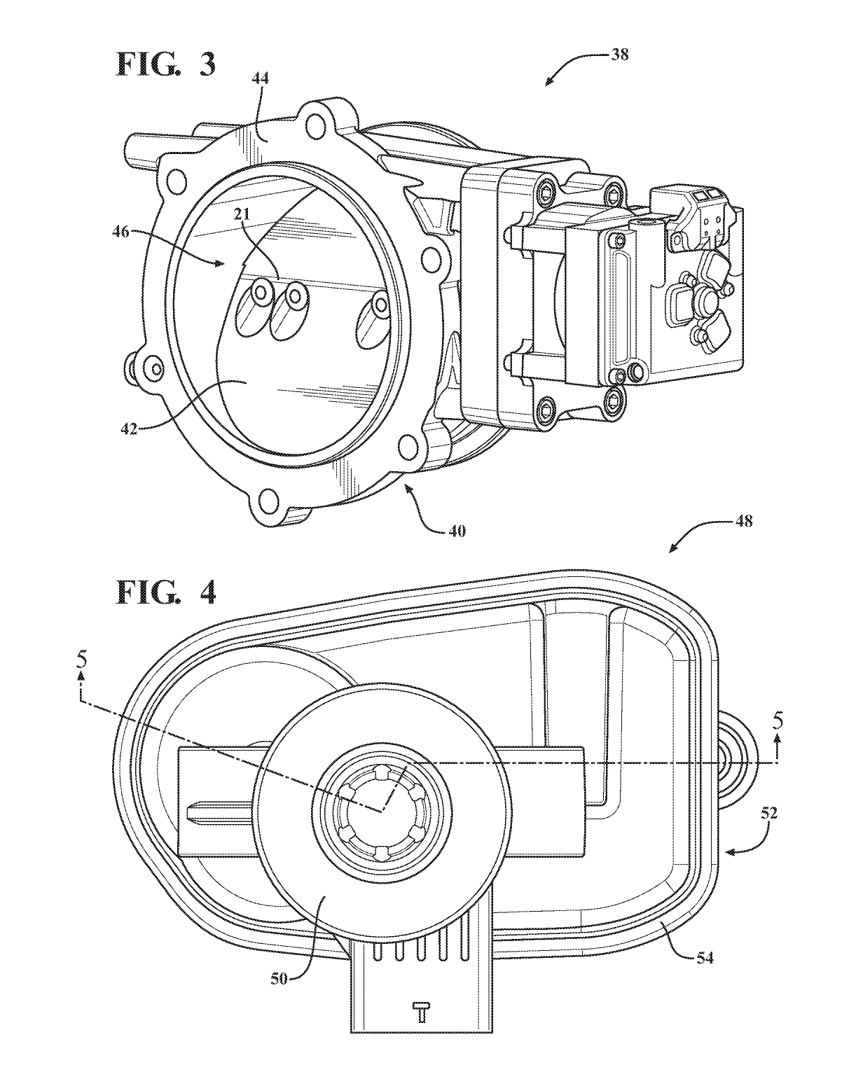

In another embodiment, the control shaft 21 may be used in a valve 38. The output shaft 88 may be coupled to the control shaft 21 of the valve 38, as shown in FIG. 3. Movement of the output shaft 88 between the plurality of positions may move the control shaft 21 of the valve 38 between a plurality of positions. The valve 38 may be further defined as a butterfly valve 40. The butterfly valve 40 may comprise a plate 42 coupled to the control shaft 21 and pivotally disposed within a valve housing 44 defining a bore 46, with the plate 42 capable of changing the cross-sectional area of the bore 46 between the plurality of positions to alter the flow of the fluid. One having skill in the art will appreciate that the valve 38 may be any particular valve capable of controlling the flow of a fluid, such as a poppet valve, a flap valve, or a ball valve.

The plurality of positions of the control shaft 21 of the valve 38 may comprise a fully open position and a fully closed position. When the control shaft 21 of the valve 38 is in the fully open position, the valve 38 induces the least amount of restriction to the flow of the fluid. When the control shaft 21 of the valve 38 is in the fully closed position, the valve 38 induces the greatest amount of restriction to the flow of the fluid. The greatest amount of restriction to the flow of the fluid may result in complete stop of fluid flow. The plurality of positions may comprise at least one intermediate position between the fully open position and the fully closed position capable of partially restricting the flow of the fluid. One having skill in the art will appreciate that the plurality of positions of the control shaft 21 of the valve 38 may be any number of positions and any type of position to create a desire fluid flow. One having skill in the art will appreciate that the actuator system 20 may be configured to actuate any suitable component through the rotation of the output shaft 88.

The actuator system 20 further comprises an actuator 48, which is shown in FIGS. 2 and 4. The actuator 48 is capable of moving the output shaft 88 between the plurality of positions and having one of a first output, having a first velocity and a first torque, and a second output, having a second velocity and a second torque. Said differently, depending on the configuration of the actuator 48 (as will be further described below) the actuator 48 may have one of the first and second outputs. The first and second outputs have differing specific properties (i.e., the first velocity, the first torque, the second velocity, and the second torque), with the specific properties having desired use in various applications. For example, the first velocity may be greater than the second velocity while the second torque may be greater than the first torque. Said differently, the first output may be capable of moving the output shaft 88 with high velocity but low torque while the second output may be capable of moving the output shaft 88 with low velocity but high torque. As such, the actuator 48 may be configured to meet desired velocity and torque characteristics of the output shaft 88. It is to be appreciated that the opposite may be true (i.e., the first velocity may be less than the second velocity while the second torque may be less than the first torque).

The actuator 48 as described herein is capable of having the first and second outputs. It is to be appreciated that the actuator 48 may be configured to have any number of suitable outputs.

Furthermore, the actuator 48 may produce rotary or linear motion. For illustrative purposes, the actuator 48 shown in the Figures produces rotary motion. The actuator 48 comprises a motor 50. The motor 50 may be a direct current (D.C.) motor. The D.C. motor may or may not include brushes to produce motion. The motor 50 may be configured to be controlled by an electrical control signal. More specifically, at least one of the ECU 30 and the actuator controller 32 control the motor 50 (and, moreover, the actuator 48) by the electrical control signal. One having skill in the art will appreciate that the motor 50 and the actuator 48 may be controlled by any suitable means, such as a mechanical switch.

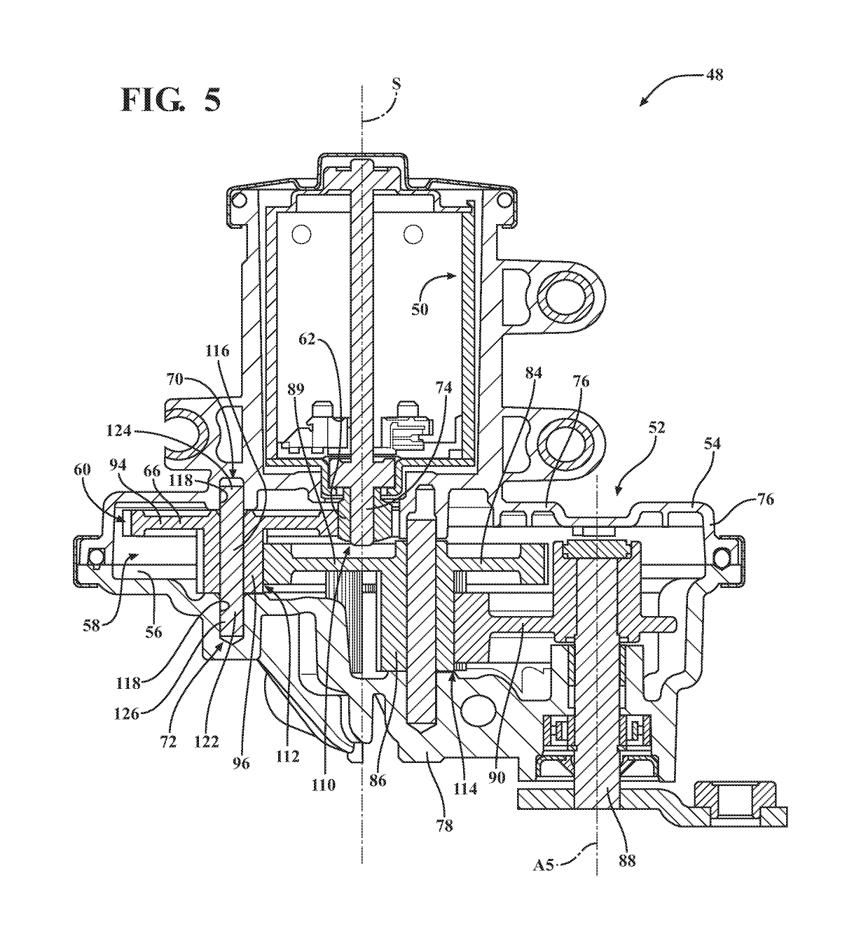

As shown in FIG. 5, the actuator 48 further comprises a gear drive assembly 52 driven by the motor 50. The gear drive assembly 52 comprises a housing 54 having an internal surface 56 defining a cavity 58 and a gear arrangement 60 disposed in the cavity 58 and comprising a drive gear 62, at least one driven gear 89, and one of a first selected gear 66 and a second selected gear 68 engageable with both of the drive and the at least one driven gears 62, 89 to transmit rotation from the drive gear 62 to the at least one driven gear 89. The drive and the at least one driven gears 62, 89 are each rotatably coupled with the housing 54. The drive and the at least one driven gears 62, 89 and the first selected gear 66 have a first gear ratio to selectively move the output shaft 88 with the first output, and the drive and the at least one driven gears 62, 89 and the second selected gear 68 have a second gear ratio not equal to the first gear ratio to selectively move the output shaft 88 with the second output. The internal surface 56 of the housing 54 defines a first gear retention feature 70 to facilitate selective rotatable coupling of the first selected gear 66 with the housing 54 and a second gear retention feature 72 to facilitate selective rotatable coupling of the second selected gear 68 with the housing 54.

The first and second gear ratios are described below in terms of respective diameters of the gears. One having skill in the art will appreciate that gear ratios may be determined by the respective diameters of the gears or by a number of gear teeth of each gear. As such, although the number of gear teeth of each gear are not explicitly discussed below, it should be appreciated that the first and second gear ratios may be determined based on the number of teeth of each gear.

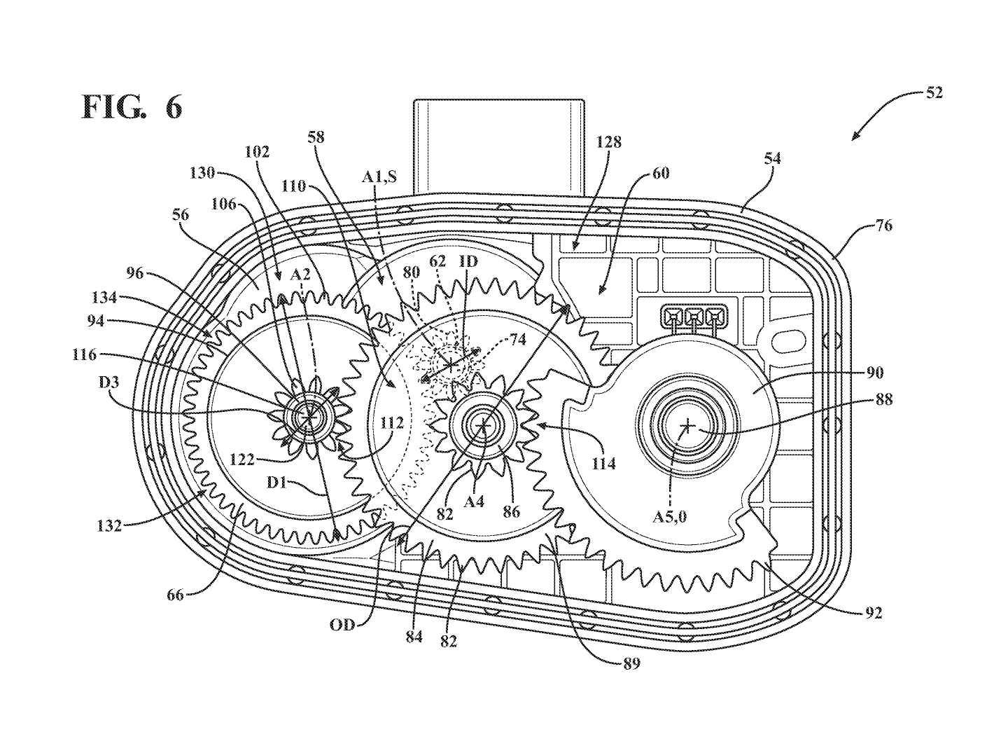

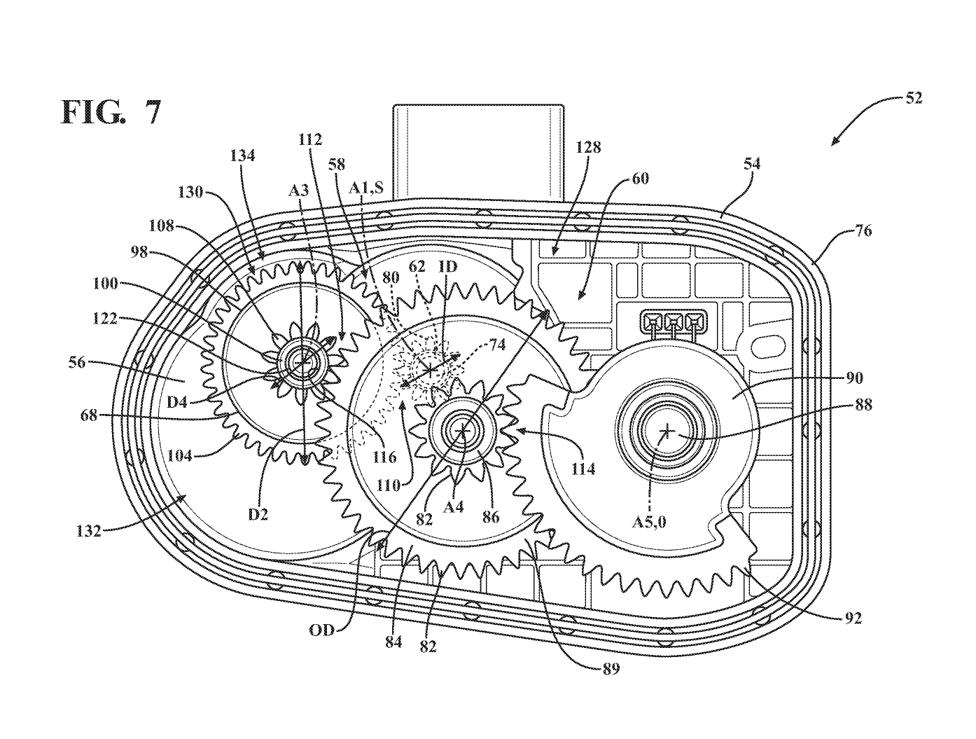

As shown in FIGS. 6 and 7, the drive gear 62 may be rotatable about a first axis A1, the first and second selected gears 66, 68 may be rotatable about second and third axes A2, A3, respectively, and the at least one driven gear 89 may be rotatable about a fourth axis A4. Each of the first, second, third, and fourth axes A1, A2, A3, A4 may be substantially parallel. One having skill in the art will appreciate that the axes A1, A2, A3, A4 may be transverse to one another.

As shown in FIG. 5, the motor 50 may have a shaft 74 rotatable about a shaft axis S and capable of transmitting rotational force with the shaft 74. The shaft 74 may extend through the housing 54 and may be at least partially disposed in the cavity 58, with the drive gear 62 operably coupled with the shaft 74. Moreover, the housing 54 may comprised of at least a first section 76 and a second section 78 each having the internal surface 56 defining the cavity 58, with the shaft 74 of the motor 50 extending through one of the first and second sections 76, 78 and is at least partially disposed in the cavity 58. The first and second sections 76, 78 may abut one another and may be sealed at the abutment to prevent debris from entering the cavity 58 therethrough. In the embodiment shown in the Figures, the shaft 74 extends through the first section 76 of the housing 54. One having skill in the art will appreciate that the shaft 74 may extend through the second section 78 of the housing 54.

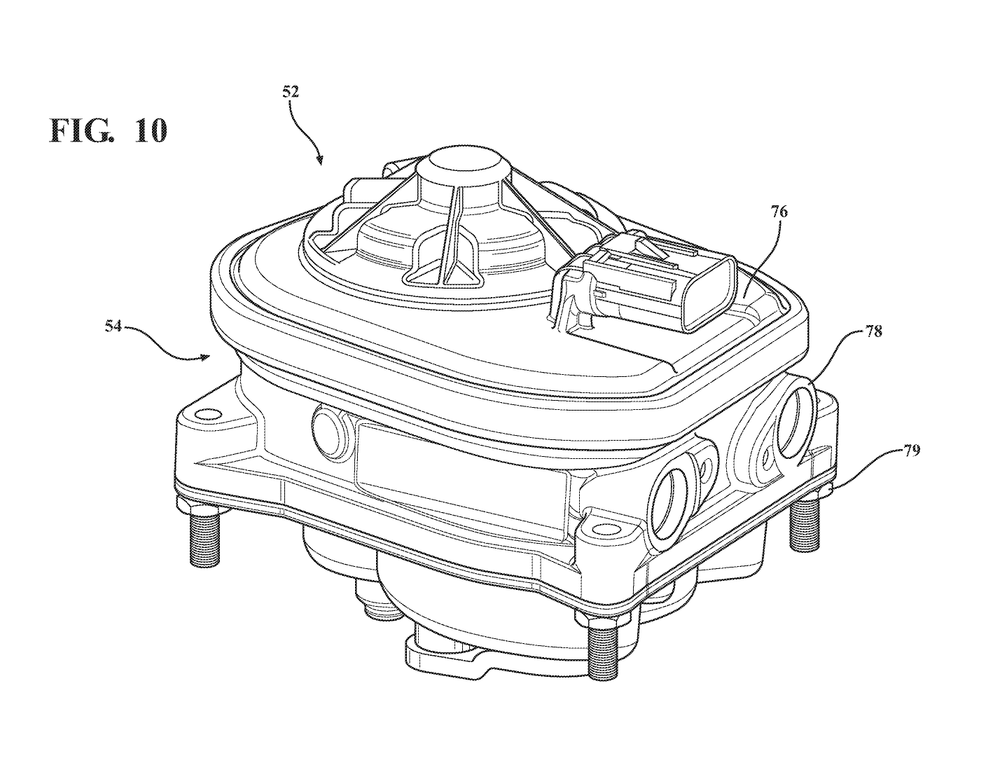

Alternatively, the housing 54 may comprise a third section 79 in addition to the first and second sections 76, 78 as shown in FIG. 10. The first, second, and third sections 76, 78, 79 each have the internal surface 56 defining the cavity 58, with the shaft 74 of the motor 50 extending through one of the first, second, and third sections 76, 78, 79 and with the shaft 74 at least partially disposed in the cavity 58. The first and second sections 76, 78 may abut one another and the second and third sections 78, 79 may abut one another. The first, second, and third sections 76, 78, 79 may be sealed at the respective abutments to prevent debris from entering the cavity 58 therethrough. One having skill in the art will appreciate that the housing 54 may be comprised of any number of sections abutting one another in any suitable order and arranged in any suitable configuration.

The drive gear 62 may be operably coupled with the shaft 74 of the motor 50. Furthermore, the drive gear 62 may be fixed to and rotatable with the shaft 74 about the shaft axis S. In one embodiment, the first axis A1 is aligned coaxial with the shaft axis S. As such, the drive gear 62 is fixed to the shaft 74 such that motion of the shaft 74 is imparted directly to the drive gear 62. One having skill in the art will appreciate that the drive gear 62 may be coupled to the shaft 74 in any suitable way.

As shown in FIGS. 6 and 7, the drive gear 62 may have gear teeth 80 extending radially and defining an input diameter ID of the drive gear 62. As shown in the Figures, the drive gear 62 may have a substantially circular configuration. As such, the drive gear 62 may be referred to as a spur gear. Furthermore, the drive gear 62 may be comparatively smaller than the at least one driven gear 89 and the first and second selected gears 66, 68. As such, the drive gear 62 may be referred to as a pinion gear. One having skill in the art will appreciate that the drive gear 62 may have any suitable gear configuration, such as a bevel gear configuration.

As shown in FIGS. 6 and 7, the at least one driven gear 89 may have gear teeth 82 extending radially and defining an output diameter OD of the at least one driven gear 89. As shown in the Figures, the at least one driven gear 89 may have a substantially circular configuration. As such, the at least one driven gear 89 may be referred to as a spur gear. Furthermore, the at least one driven gear 89 may have a first gear section 84 and a second gear section 86 spaced from and fixed to the first gear section 84. Both of the first and second gear sections 84, 86 may have a substantially circular configuration. As such, the at least one driven gear 89 may be referred to as two spur gears. In addition, the first and second gear sections 84, 86 may be fixed to one another such that the first and second gear sections 84, 86 rotate in unison about the fourth axis A4. As such, the at least one driven gear 89 may be referred to as a compound gear. One having skill in the art will appreciate that the at least one driven gear 89 may have any suitable gear configuration, such as a bevel gear configuration.

The at least one driven gear 89 may be rotatable about the fourth axis A4 and may be operably coupled with the output shaft 88. The output shaft 88 may extend through the housing 54 from the cavity 58 along an output axis O. More specifically, the output shaft 88 may extend through the second section 78 of the housing 54. The output shaft 88 may be supported by the second section 78 of the housing 54 by a bearing and a bushing, which allows the output shaft 88 to rotate about the output axis O. The rotation of the at least one driven gear 89 may rotate the output shaft 88 between the plurality of positions. In one embodiment, the at least one driven gear 89 may be fixed to the output shaft 88 in what is commonly referred to in the art as a two-stage gear drive.

Alternatively, the at least one driven gear 89 of the gear arrangement 60 may be further defined as a first driven gear 89 and a second driven gear 90 engageable with the first driven gear 89, as shown in FIGS. 6 and 7. In such an embodiment, the description of the at least one driven gear 89 above is applicable to the first driven gear 89. As such, the first driven gear 89 may be rotatable about the fourth axis A4, the first and second gear sections 84, 86, and the gear teeth 82 extending radially and defining the output diameter OD, as described above.

The first gear section 84 of the first driven gear 89 may be engageable with the one of the first and second selected gears 66, 68 and the second gear section 86 of the first driven gear 89 may be engageable with the second driven gear 90. The second driven gear 90 may have gear teeth 92 extending radially. The second driven gear 90 may be rotatably coupled with the housing 54 along a fifth axis A5. As shown in FIG. 5, the fifth axis A5 may be substantially parallel to the first, second, third, and fourth axes A1, A2, A3, A4. As shown in the Figures, the second driven gear 90 may have a partially circular configuration. As such, the second driven gear 90 may be referred to as a partial spur gear. Furthermore, the second driven gear 90 may be referred to as a sector gear. One having skill in the art will appreciate that the second driven gear 90 may have any suitable gear configuration, such as a complete spur gear or a bevel gear configuration.

As shown in FIG. 5, the second driven gear 90 may be fixed to the output shaft 88 in what is commonly referred to in the art as a three-stage gear drive. The fifth axis A5 of the second driven gear 90 may be coaxial with the output axis O of the output shaft 88. The drive gear 62 may be indirectly coupled to the output shaft 88 through the second driven gear 90.

As shown in FIGS. 6 and 7, each of the one of the first and second selected gears 66, 68 may have a first gear section 94, 98 and a second gear section 96, 100 spaced from and fixed to the first gear section 94, 98, with the first gear section 94, 98 of each of the first and second selected gears 66, 68 being engageable with the drive gear 62 and the second gear section 96, 100 of each of the first and second selected gears 66, 68 being engageable with the at least one driven gear 89. More specifically, the second gear section 96, 100 of each of the first and second selected gears 66, 68 may be engageable with the first driven gear 89. The first gear section 94, 98 of each of the first and second selected gears 66, 68 may have gear teeth 102, 104 extending radially and defining a first diameter D1 of the first selected gear 66 (shown in FIG. 6) and a second diameter D2 (shown in FIG. 7) of the second selected gear 68. The second gear section 96, 100 of each of the first and second selected gears 66, 68 may have gear teeth 106, 108 extending radially and defining a third diameter D3 (shown in FIG. 6) of the first selected gear 66 and a fourth diameter D4 (shown in FIG. 7) of the second selected gear 68. Both of the first and second gear sections 94, 96, 98, 100 of each of the first and second selected gears 66, 68 may have a substantially circular configuration. As such, each of the first and second selected gears 66, 68 may be referred to as two spur gears. In addition, the first and second gear sections 94, 96, 98, 100 may be fixed to one another such that the first and second gear sections 94, 96, 98, 100 rotate in unison about the second and third axes A2, A3, respectively. As such, each of the first and second selected gears 66, 68 may be referred to as a compound gear. One having skill in the art will appreciate that the first and second selected gears 66, 68 may have any suitable gear configuration, such as a bevel gear configuration.

As shown in FIGS. 6 and 7, the gear teeth 102, 104 of the first gear section 94, 98 of the first and second selected gears 66, 68 may be engageable with the gear teeth 80 of the drive gear 62 to define a first gear stage 110. The first gear section 94, 98 of the first and second selected gears 66, 68 and the drive gear 62 may be positioned on a first plane, shown in FIG. 5. The gear teeth 106, 108 of the second gear section 96, 100 of the first and second selected gears 66, 68 may be engageable with the gear teeth 82 of the at least one driven gear 89 to define a second gear stage 112. More specifically, the gear teeth 106, 108 of the second gear section 96, 100 of the first and second selected gears 66, 68 may be engageable with the gear teeth 82 of the first driven gear 89 to define the second gear stage 112. The second gear section 96, 100 of the first and second selected gears 66, 68 and the at least one driven gear 89 (i.e., the first driven gear 89) may be positioned on a second plane. As shown in FIG. 5, the first and second planes are spaced from and substantially parallel to one another. It is to be appreciated that the first and second planes may be substantially the same plane or transverse to one another. If the gear arrangement 60 has the second driven gear 90, the gear teeth 82 of the second gear section 86 of the first driven gear 89 may be engageable with the gear teeth 92 of the second driven gear 90 to define a third gear stage 114.

As shown in FIGS. 6, 7, 8, and 9, the first and second diameters D1, D2 of the first gear sections 94, 98 of the first and second selected gears 66, 68, respectively, may correspond with the first and second gear retention features 70, 72 of the housing 54, respectively, to facilitate engagement of the first gear section 94, 98 of the one of the first and second selected gears 66, 68 with the drive gear 62 having the input diameter ID. Likewise, the third and fourth diameters D3, D4 of the second gear sections 96, 100 of the first and second selected gears 66, 68, respectively, may correspond with the first and second gear retention features 70, 72 of the housing 54, respectively, to facilitate engagement of the second gear section 96, 100 of the one of the first and second selected gears 66, 68 with the at least one driven gear 89 having the output diameter OD (i.e., the first driven gear 89 when the second driven gear 90 is present). Said differently, the housing 54 is configured to position each of the first selected gear 66, having the first and third diameters D1, D3, and the second selected gear 68, having the second and fourth diameters D2, D4, into engagement with each of the drive and the at least one driven gears 62, 89. The configuration of the housing 54 to position each of the first and second selected gears 66, 68 will be described in greater detail below.

As described above, the drive and the at least one driven gears 62, 89 and the first selected gear 66 have the first gear ratio to selectively move the output shaft 88 with the first output, and the drive and the at least one driven gears 62, 89 and the second selected gear 68 have the second gear ratio not equal to the first gear ratio to selectively move the output shaft 88 with the second output. The first and second selected gears 66, 68 are selectively placed into engagement with the drive and the at least one driven gears 62, 89. As such, the diameters of the first and second selected gears 66, 68 facilitate the difference in the first and second gear ratios (and the first and second outputs). For example, as shown in the Figures, the third and fourth diameters D3, D4 of the second gear sections 96, 100 of the first and second selected gears 66, 68, respectively, are substantially equal. However, the first and second diameters D1, D2 of the first gear sections 94, 98 of the first and second selected gears 66, 68, respectively, are different. Specifically, the first diameter D1 of the first gear section 94 of the first selected gear 66 is greater than the second diameter D2 of the first gear section 98 of the second selected gear 68. As such, the first velocity of the first output is less than the second velocity of the second output and the first torque of the first output is greater than the second torque of the second output. Said differently, the first selected gear 66 may provide greater mechanical advantage than the second selected gear 68, while the second selected gear 68 may provide faster response than the first selected gear 66. It is to be appreciated that the opposite may true (i.e., the first velocity may be greater than the second velocity and the first torque may be less than the second torque).

Although the gear arrangement 60 as described herein comprises the first and second selected gears 66, 68 with one of the two being selected and positioned into the cavity 58 to the engage the drive and the at least one driven gears 62, 89, one having skill in the art will appreciate that more than two selected gears may be used in accordance with the invention. Moreover, one having skill in the art will appreciate that more than one selected gears may be used at any given time, as will be described in greater detail below. Furthermore, more than one selected gear may engage the drive and the at least one driven gears 62, 89 without escaping the scope of the present invention. Also, the total number of gears in the gear arrangement 60 are demonstrative in nature. It is to be appreciated that the gear arrangement 60 may comprise any total number of gears.

The operation of transmitting rotation from the motor 50 to the output shaft 88 in accordance with the embodiment shown in the Figures is described below for illustrative purposes. One having skill in the art will appreciate that, although not expressly recited herein, numerous operations are possible in accordance with the present invention.

When the motor 50 is activated, the motor 50 rotates the shaft 74 about the shaft axis S. The shaft 74 is coupled to the drive gear 62, which causes the drive gear 62 to rotate about the first axis A1. The drive gear 62 engages the first gear section 94, 98 of first selected gear 66 or the second selected gear 68 (whichever is disposed in the housing 54) at the first stage, which causes the first selected gear 66 or the second selected gear 68 to rotate about the second axis A2 or the third axis A3, respectively. The first gear section 94, 98 and the second gear section 96, 100 of each of the first and second selected gears 66, 68 are fixed to one another. As such, rotation of the first gear section 94, 98 results in simultaneous rotation of the second gear section 96, 100.

The second gear section 96, 100 of the first selected gear 66 or the second selected gear 68 (whichever is disposed in the housing 54) engages the first gear section 84 of the first driven gear 89 at the second stage, which causes the first driven gear 89 to rotate about the fourth axis A4. The first gear section 84 and the second gear section 86 of the first driven gear 89 are fixed to one another. As such, rotation of the first gear section 84 results in simultaneous rotation of the second gear section 86. The second gear section 86 of the first driven gear 89 engages the second driven gear 90 at the third stage, which causes the second driven gear 90 to rotate about the fifth axis A5. The second driven gear 90 is coupled to the output shaft 88, which causes the output shaft 88 to rotate about the output axis O between the plurality of positions.

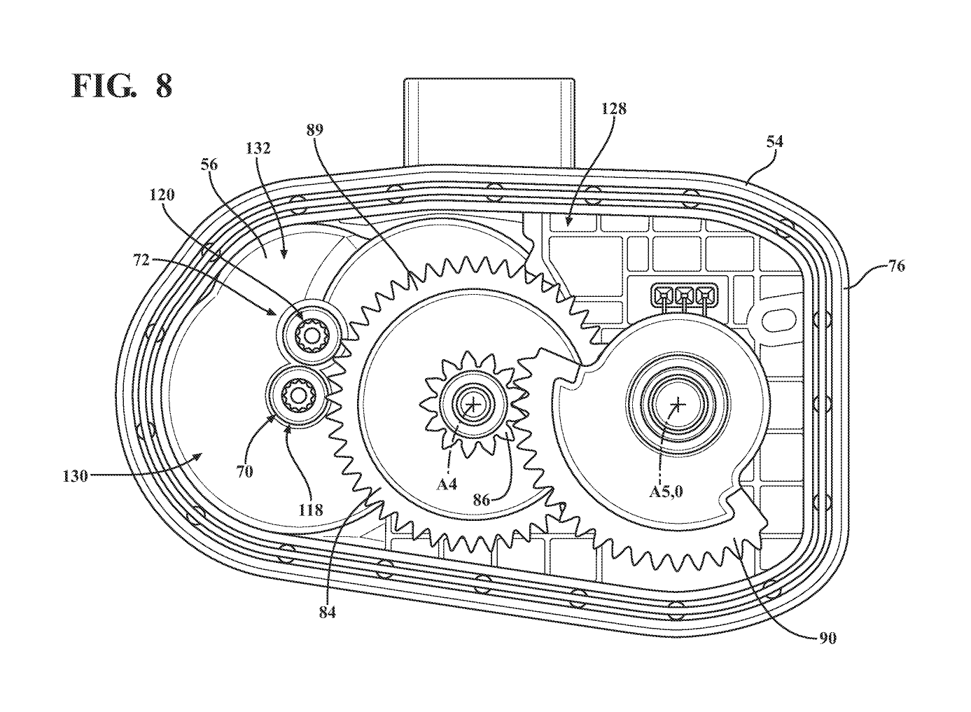

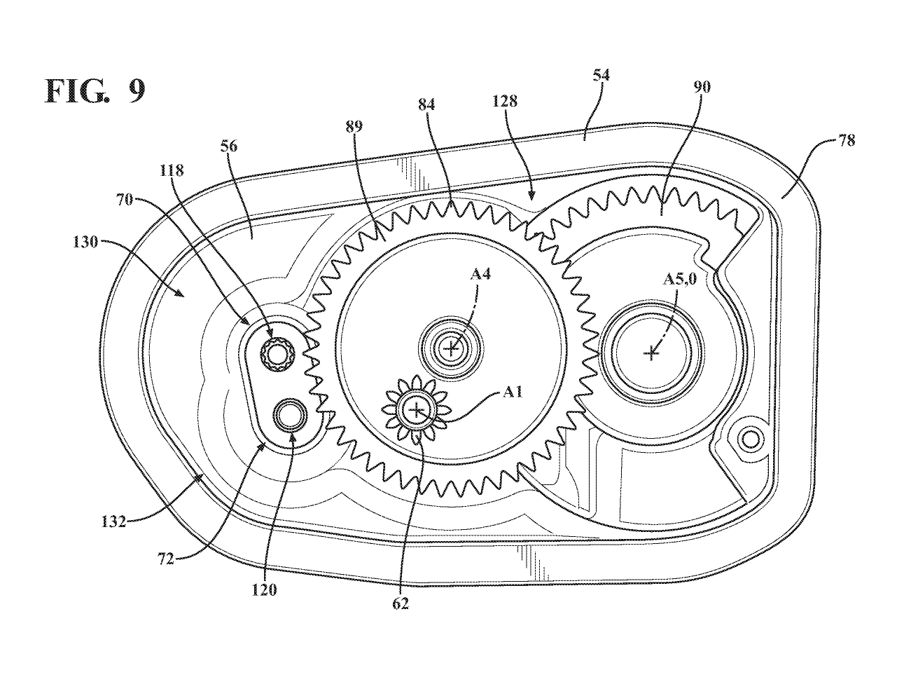

Each of the first and second selected gears 66, 68 may define a hole 116 extending therethrough (as shown in FIGS. 6 and 7), with the hole 116 of the first and second selected gears 66, 68 corresponding with the first and second gear retention features 70, 72 (as shown in FIGS. 8 and 9), respectively, to facilitate selective rotatable coupling of the one of the first and second selected gears 66, 68 with the housing 54. The holes 116 of the first and second selected gears 66, 68 are defined along the second and third axes A2, A3. One having skill in the art will appreciate that the hole 116 may be defined anywhere within the first and second selected gears 66, 68.

As shown in FIGS. 8 and 9, the internal surface 56 of the housing 54 may define a pair of first gear pockets 118 as the first gear retention feature 70, and the internal surface 56 of the housing 54 may define a pair of second gear pockets 120 as the second gear retention feature 72. More specifically, the internal surfaces 56 of the at least the first and second sections 76, 78 of the housing 54 may each individually define the first gear pocket 118 which collectively define the first gear retention feature 70. The internal surfaces 56 of the at least the first and second sections 76, 78 of the housing 54 may each define the second gear pocket 120 which collectively define the second gear retention feature 72.

As shown in FIG. 5, the gear drive assembly 52 may further comprise a pin 122 extending between a first end 124 and a second end 126 through the hole 116 of the one of the first and second selected gears 66, 68. The first and second ends 124, 126 of the pin 122 may be individually disposed within one of the pair of first gear pockets 118 and the pair of second gear pockets 120 of the housing 54 to facilitate selective rotatable coupling of the one of the first and second selected gears 66, 68 with the housing 54. More specifically, each of the pair of first gear pockets 118 may have a cylindrical configuration, with the pair of first gear pockets 118 opening toward one another to receive the pin 122 and operably couple the pin 122 to the housing 54. Likewise, each of the pair of second gear pockets 120 may have a cylindrical configuration, with the pair of second gear pockets 120 opening toward one another to receive the pin 122 and operably couple the pin 122 to the housing 54. The pin 122 may have a cylindrical configuration corresponding to the cylindrical configurations of the first and second gear pockets 118, 120. The cylindrical configuration of the first and second gear pockets 118, 120 accept the pin 122 and retain the pin 122 laterally to the second and third axes A2, A3, respectively.

The pin 122 may be disposed within each of the first gear pockets 118 when the first selected gear 66 is disposed in the cavity 58, with the first gear section 94 having the first diameter D1 engaged with the drive gear 62 having the input diameter ID to define the first gear stage 110, and with the second gear section 96 having the third diameter D3 engaged with the at least one driven gear 89 having the output diameter OD to define the second gear stage 112 for selectively moving the output shaft 88 with the first output. More specifically, the second gear section 96 having the third diameter D3 may be engaged with the first driven gear 89 having the output diameter OD to define the second gear stage 112 for selectively moving the output shaft 88 with the first output. Likewise, the pin 122 may be disposed within each of the second gear pockets 120 when the second selected gear 68 is disposed in the cavity 58, with the first gear section 98 having the second diameter D2 engaged with the drive gear 62 having the input diameter ID to define the first gear stage 110, and with the second gear section 100 having the fourth diameter D4 engaged with the at least one driven gear 89 having the output diameter OD to define the second gear stage 112 for selectively moving the output shaft 88 with the second output. More specifically, the second gear section 100 having the fourth diameter D4 may be engaged with the first driven gear 89 having the output diameter OD to define the second gear stage 112 for selectively moving the output shaft 88 with the second output. Therefore, the pair of second gear pockets 120 may be empty when the first and second ends 124, 126 of the pin 122 are individually disposed within the pair of first gear pockets 118 and the pair of first gear pockets 118 may be empty when the first and second ends 124, 126 of the pin 122 are individually disposed within the pair of second gear pockets 120.

As shown in FIGS. 6-9, the internal surface 56 may segregate the cavity 58 into at least a common chamber 128 having a configuration corresponding with the drive and the at least one driven gears 62, 89, a first chamber 130 having a configuration corresponding with the first selected gear 66, and a second chamber 132 having a configuration corresponding with the second selected gear 68. The first and second chambers 130, 132 may open into the common chamber 128, with the configurations of the common chamber 128 and the first and second chambers 130, 132 defining a gap 134 between the drive, the at least one driven, first selected, and second selected gears 62, 89, 66, 68 and the housing 54.

The gap 134 between the drive and the at least one driven gears 62, 89 and the first and second selected gears 66, 68 and the housing 54 is nominal to facilitate rotation of the first and second selected gears 66, 68. Said differently, the common, first, and second chambers 128, 130, 132 have a shape and a configuration similar to the drive and the at least one driven gears 62, 89 and the first and second selected gears 66, 68. As such, the drive and the at least one driven gears 62, 89 and the first and second selected gears 66, 68 may freely rotate within the cavity 58 without excessive gaps 134 between the gears and the housing 54. The nominal gap 134 reduces the amount of material required to the produce the housing 54.

In one embodiment, the first and second selected gears 66, 68 are both selectively rotatably coupled to the housing 54 at one of the first and second gear retention features 70, 72. Moreover, only of the first and second gear retention features 70, 72 may be defined by the internal surface 56 of the housing 54.

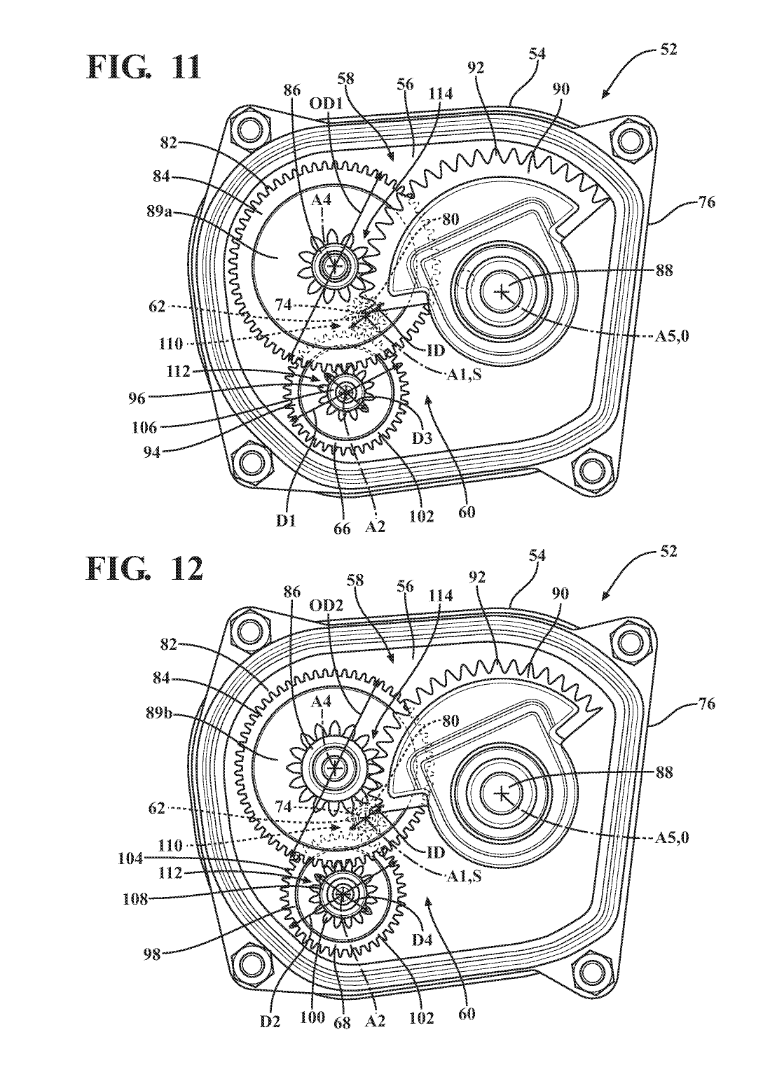

In order to facilitate engagement of the first selected gear 66 and the second selected gear 68 with both of the drive gear 62 and the at least one driven gear 89 (more specifically, the first driven gear 89 when the second driven gear 90 is present as shown in FIGS. 11 and 12), the at least one driven gear 89 includes one of a first selected first driven gear 89a engageable with the first selected gear 66 (as shown in FIG. 11) and a second selected first driven gear 89b engageable with the second selected gear 68 (as shown in FIG. 12) to transmit rotation from the drive gear 62 to one of the first and second selected first driven gears 89a, 89b. As such, the first selected gear 66 is engageable with both the drive gear 62 and the first selected first driven gear 89a while the second selected gear 68 is engageable with both the drive gear 62 and the second selected first drive driven gear 89b. Moreover, as shown in FIGS. 11 and 12, the first and second selected first driven gears 89a, 89b may each independently engage the second driven gear 90, as described. One having skill in the art will appreciate that the second driven gear 90 may be absent such that the selected one of the first and second selected first driven gears 89a, 89b may operably coupled to the output shaft 88.

The above description of the housing 52 (aside from defining only one of the first and second gear retention features 70, 72) is applicable to the present embodiment. Moreover, the above description of the first and second selected gears 66, 68 is applicable to the present embodiment. For example, the first selected gear 66 may have the first and second gear sections 94, 96 having the gear teeth 102, 106 and the first and third diameters D1, D3, as described above, while the second selected gear 68 may have the first and second gear sections 98, 100 having the gear teeth 104, 108 and the second and fourth diameters D2, D4, as described above and generally shown in FIGS. 11 and 12.

Moreover, the description above of the first driven gear 89 is generally applicable to the first and second selected first driven gears 89a, 89b. For example, the first and second selected first driven gears 89a, 89b may have the first and second gear sections 84, 86 having the gear teeth 82, as shown in FIGS. 11 and 12. However, the the first and second selected first driven gears 89a, 89b differ from the first driven gear 89 in that first gear section 84 of the first selected first driven gear 89a has a first output diameter OD1 and the first gear section 86 of the second selected first driven gear 89b has a second output diameter OD2, which is different than the first output diameter OD1.

The diameters associated with the drive gear 62, the first and second selected gears 66, 68, and the first and second selected first driven gears 89a, 89b are designed to ensure engagement of the drive gear 62, the first selected gear 66, and the first selected first driven gear 89a in one configuration and engagement of the drive gear 62, the second selected gear 68, and the second selected first driven gear 89b in another configuration while both configurations utilize the first gear retention feature 70 of the housing 52 for both the first and second selected gears 66, 68. Said differently, the drive 62 gear having the input diameter ID is configured to engage both the first gear section 94 of the first selected gear 66 having the first diameter D1 (as shown in FIG. 11) and the first gear section 98 of the second selected gear 68 having the second diameter D2 (as shown in FIG. 12), as described above. Furthermore, the second gear section 96 of the first selected gear 66 having the third diameter D3 is configured to engage the first gear section 84 of the first selected first driven gear 89a having the first output diameter OD1 (as shown in FIG. 11) while the second gear section 100 of the second selected gear 68 having the fourth diameter D4 is configured to engage the first gear section 84 of the second selected first driven gear 89b having the second output diameter OD2 (as shown in FIG. 12).

As such, the drive gear 62, the first selected gear 66, and the first selected first driven gear 89a have the first gear ratio for selectively moving the output shaft 88 with the first output. Likewise, the drive gear 62, the second selected gear 68, and the second selected first driven gear 89b have the second gear ratio for selectively moving the output shaft 88 with the second output.

The subject invention further provides for a method of manufacturing the gear drive assembly 52 for use with and driven by the motor 50 in the actuator 48. As described above, the actuator 48 is capable of moving the output shaft 88 between the plurality of positions, with the actuator 48 having the one of the first output, having the first velocity and the first torque, and the second output, having the second velocity and the second torque. As shown in FIGS. 6 and 7, the gear drive assembly 52 comprises the housing 54 having the internal surface 56 defining the cavity 58, and the gear arrangement 60 disposed in the cavity 58 and comprising the drive gear 62, the at least one driven gear 89, and the one of the first selected gear 66 and the second selected gear 68. The drive and the at least one driven gears 62, 89 and the first selected gear 66 have the first gear ratio for selectively moving the output shaft 88 with the first output. The drive and the at least one driven gears 62, 89 and the second selected gear 68 have the second gear ratio not equal to the first gear ratio for selectively moving the output shaft 88 with the second output.

The method comprises the steps of rotatably coupling the drive and the at least one driven gears 62, 89 with the housing 54 within the cavity 58, selecting one of the first selected gear 66 (as shown in FIG. 6) and the second selected gear 68 (as shown in FIG. 7), engaging the one of the first and second selected gears 66, 68 with both of the drive and the at least one driven gears 62, 89, and rotatably coupling the one of the first and second selected gears 66, 68 with the housing 54 within the cavity 58.

As described above and generally shown in FIG. 5, the internal surface 56 of the housing 54 defines the first gear retention feature 70 to facilitate selective rotatable coupling of the first selected gear 66 with the housing 54 and the second gear retention feature 72 to facilitate selective rotatable coupling of the second selected gear 68 with the housing 54. As such, the step of rotatably coupling the one of the first and second selected gears 66, 68 with the housing 54 may be further defined as the step of rotatably coupling the one of the first and second selected gears 66, 68 with the respective one of the first and second gear retention features 70, 72.

As further described above, each of the first and second selected gears 66, 68 may define the hole 116 extending therethrough, and the internal surface 56 of the housing 54 may defines the pair of first gear pockets 118 as the first gear retention feature 70 and the pair of second gear pockets 120 as the second gear retention feature 72. As such, the step of rotatably coupling the one of the first and second selected gears 66, 68 with the respective one of the first and second gear retention features 70, 72 may be further defined as the steps of inserting the pin 122 through the hole 116 of the one of the first and second selected gears 66, 68 and inserting the pin 122 into the respective one of the pair of first gear pockets 118 and the pair of second gear pockets 120.

As described above, the at least one driven gear 89 includes one of a first selected first driven gear 89a engageable with the first selected gear 66 (shown in FIG. 11) and a second selected first driven gear 89b engageable with the second selected gear 68 (shown in FIG. 12) to transmit rotation from the drive gear 62 to one of the first and second selected first driven gear 89a, 89b. The method may further include the step of selecting one of the first and second selected first driven gears 89a, 89b corresponding with the selected one of the first and second selected gears 66, 68. Furthermore, the step of engaging the one of the first and second selected gears 66, 68 with both of the drive gear 62 and the at least one driven gears 89 may be further defined as engaging the one of the first and second selected gears 66, 68 with both of the drive gear 62 and the respective one of the first and second selected first driven gears 89a, 89b.

The gear drive assembly 52 allows for different properties (i.e., the first and second outputs) by selecting between the first and second selected gears 66, 68. The housing 54 is correspondingly designed to accommodate each of the first and second selected gears 66, 68. As such, only one housing is needed to accommodate two different outputs. Because one housing is needed rather than two, manufacturing costs are reduced.

The invention has been described in an illustrative manner, and it is to be understood that the terminology which has been used is intended to be in the nature of words of description rather than of limitation. As is now apparent to those skilled in the art, many modifications and variations of the subject invention are possible in light of the above teachings. It is, therefore, to be understood that within the scope of the appended claims, wherein reference numerals are merely for convenience and are not to be in any way limiting, the invention may be practiced otherwise than as specifically described.

What is claimed is:

1. A gear drive assembly for use with and driven by a motor in an actuator, with the actuator capable of moving an output shaft between a plurality of positions, with the actuator having one of a first output, having a first velocity and a first torque, and a second output, having a second velocity and a second torque, said gear drive assembly comprising:
a housing having an internal surface defining a cavity; and
a gear arrangement disposed in said cavity and comprising a drive gear, at least one driven gear, and one of a first selected gear and a second selected gear engageable with both of said drive and the at least one driven gears to transmit rotation from said drive gear to said at least one driven gear, with said drive and the at least one driven gears each rotatably coupled with said housing;
wherein said drive and the at least one driven gears and said first selected gear have a first gear ratio for selectively moving the output shaft with the first output, and said drive and the at least one driven gears and said second selected gear have a second gear ratio not equal to said first gear ratio for selectively moving the output shaft with the second output; and
wherein said internal surface of said housing defines a first gear retention feature to facilitate selective rotatable coupling of said first selected gear with said housing, and a second gear retention feature to facilitate selective rotatable coupling of said second selected gear with said housing.

2. The gear drive assembly as set forth in claim 1, wherein each of said first and second selected gears define a hole extending therethrough, with said hole of said first and second selected gears corresponding with said first and second gear retention features, respectively, to facilitate selective rotatable coupling of said one of said first and second selected gears with said housing.

3. The gear drive assembly as set forth in claim 2, wherein said internal surface of said housing defines a pair of first gear pockets as said first gear retention feature, and said internal surface of said housing defines a pair of second gear pockets as said second gear retention feature.

4. The gear drive assembly as set forth in claim 3, further comprising a pin extending between a first end and a second end through said hole of said one of said first and second selected gears, with said first and second ends individually disposed within one of said pair of first gear pockets and said pair of second gear pockets of said housing to facilitate selective rotatable coupling of said one of said first and second selected gears with said housing.

5. The gear drive assembly as set forth in claim 4, wherein said each of said pair of first gear pockets have a cylindrical configuration, with said pair of first gear pockets opening toward one another to receive said pin and operably couple said pin to said housing.

6. The gear drive assembly as set forth in claim 4, wherein said each of said pair of second gear pockets have a cylindrical configuration, with said pair of second gear pockets opening toward one another to receive said pin and operably couple said pin to said housing.

7. The gear drive assembly as set forth in claim 4, wherein said pair of second gear pockets are empty when said first and second ends of said pin are individually disposed within said pair of first gear pockets and said pair of first gear pockets are empty when said first and second ends of said pin are individually disposed within said pair of second gear pockets.

8. The gear drive assembly as set forth in claim 1, wherein each of said one of said first and second selected gears has a first gear section and a second gear section spaced from and fixed to said first gear section, with said first gear section of each of said first and second selected gears being engageable with said drive gear and said second gear section of each of said first and second selected gears being engageable with said at least one driven gear.

9. The gear drive assembly as set forth in claim 8, wherein said first gear section of each of said first and second selected gears has gear teeth extending radially and defining a first diameter of said first selected gear and a second diameter of said second selected gear.

10. The gear drive assembly as set forth in claim 9, wherein said drive gear has gear teeth extending radially and defining an input diameter of said drive gear, with said first and second diameters of said first gear sections of said first and second selected gears, respectively, corresponding with said first and second gear retention features of said housing, respectively, to facilitate engagement of said first gear section of said one of said first and second selected gears with said drive gear having said input diameter.

11. The gear drive assembly as set forth in claim 8, wherein said second gear section of each of said first and second selected gears has gear teeth extending radially and defining a third diameter of said first selected gear and a fourth diameter of said second selected gear.

12. The gear drive assembly as set forth in claim 11, wherein said at least one driven gear has gear teeth extending radially and defining an output diameter of said at least one driven gear, with said third and fourth diameters of said second gear sections of said first and second selected gears, respectively, corresponding with said first and second gear retention features of said housing, respectively, to facilitate engagement of said second gear section of said one of said first and second selected gears with said at least one driven gear having said output diameter.

13. The gear drive assembly as set forth in claim 1, wherein said housing is further comprised of at least a first section and a second section each having said internal surface, with said internal surfaces defining said cavity.

14. The gear drive assembly as set forth in claim 13, wherein said internal surfaces of said at least said first and second sections of said housing each individually define a first gear pocket which collectively define said first gear retention feature and said internal surfaces of said at least said first and second sections of said housing each define a second gear pocket which collectively define said second gear retention feature.

15. The gear drive assembly as set forth in claim 1, wherein said internal surface segregates said cavity into at least a common chamber having a configuration corresponding with said drive and the at least one driven gears, a first chamber having a configuration corresponding with said first selected gear, and a second chamber having a configuration corresponding with said second selected gear, with said first and second chambers opening into said common chamber, and with said configurations of said common chamber and said first and second chambers defining a gap between said drive, the at least one driven, first selected, and second selected gears and said housing.

16. An actuated system comprising:
an output shaft movable between a plurality of positions;
an actuator capable of moving said output shaft between said plurality of positions and having one of a first output, having a first velocity and a first torque, and a second output, having a second velocity and a second torque; said actuator comprising:
a motor;
a gear drive assembly driven by said motor; said gear drive assembly comprising:
a housing having an internal surface defining a cavity; and
a gear arrangement disposed in said cavity and comprising a drive gear, at least one driven gear, and one of a first selected gear and a second selected gear engageable with both of said drive and the at least one driven gears to transmit rotation from said drive gear to said at least one driven gear, with said drive and the at least one driven gears each rotatably coupled with said housing;
wherein said drive and the at least one driven gears and said first selected gear have a first gear ratio to selectively move said output shaft with said first output, and said drive and the at least one driven gears and said second selected gear have a second gear ratio not equal to said first gear ratio to selectively move said output shaft with said second output; and
wherein said internal surface of said housing defines a first gear retention feature to facilitate selective rotatable coupling of said first selected gear with said housing and a second gear retention feature to facilitate selective rotatable coupling of said second selected gear with said housing.

17. The actuated system as set forth in claim 16, wherein said motor has a shaft rotatable about a shaft axis and capable of transmitting rotational force with said shaft.

18. The actuated system as set forth in claim 17, wherein said shaft extends through said housing and is at least partially disposed in said cavity, with said drive gear operably coupled with said shaft.

19. The actuated system as set forth in claim 17, wherein said drive gear is fixed to and rotatable with said shaft about said shaft axis.

20. The actuated system as set forth in claim 16, wherein said at least one driven gear is rotatable about a fourth axis and is operably coupled with said output shaft to move said output shaft between said plurality of positions.

21. An actuator capable of moving an output shaft between a plurality of positions and having one of a first output, having a first velocity and a first torque, and a second output, having a second velocity and a second torque; said actuator comprising:
a motor having a shaft rotatable about a shaft axis and capable of transmitting rotational force with said shaft, with said motor configured to be controlled by an electrical control signal;
a gear drive assembly driven by said motor; said gear drive assembly comprising:
a housing comprising a first section and a second section each having an internal surface, with said internal surfaces defining a cavity, with said shaft of said motor extending through one of said first and second sections and is at least partially disposed within said cavity, with said internal surfaces of said first and second sections of said housing each defining a first gear pocket which collectively define a first gear retention feature and with said internal surfaces of said first and second sections of said housing each defining a second gear pocket which collectively define a second gear retention feature; and
a gear arrangement disposed in said cavity and comprising:
a drive gear rotatable about a first axis aligned coaxial with said shaft axis and operably coupled with said shaft of said motor, with said drive gear having gear teeth extending radially from said first axis and defining an input diameter of said drive gear;
one of a first selected gear and a second selected gear rotatable about one of a second axis and a third axis, respectively, with said first and second selected gears each having a first gear section and a second gear section spaced from and fixed to said first gear section, with said first gear section of each of said first and second selected gears having gear teeth extending radially from said second axis and said third axis, respectively, and defining one of a first diameter of said first gear section of said first selected gear and a second diameter of said first gear section of said second selected gear, with said gear teeth of said first gear section of said first and second selected gears engageable with said gear teeth of said drive gear to define a first gear stage, with said second gear section of said first and second selected gears having gear teeth extending radially from said second axis and said third axis, respectively, and defining one of a third diameter of said second gear section of said first selected gear and a fourth diameter of said second gear section of said second selected gear, and with both of said first and second selected gears defining a hole extending therethrough along said second and third axes, respectively;
at least one driven gear rotatable about a fourth axis and operably coupled with the output shaft movable between the plurality of positions, with said output gear having gear teeth extending radially from said fourth axis and defining an output diameter of said output gear, with said gear teeth of said second gear section of said first and second selected gears engageable with said gear teeth of said output gear to define a second gear stage; and
a pin extending between a first end and a second end through said hole of said one of said first and second selected gears and individually disposed within one of said first gear pockets and said second gear pockets of said first and second gear sections of said housing to facilitate rotation of said one of said first and second selected gears about the respective one of said second and third axes;
wherein said pin is disposed within each of said first gear pockets when said first selected gear is disposed in said cavity, with said first gear section having said first diameter engaged with said drive gear having said input diameter to define said first gear stage, and with said second gear section having said third diameter engaged with said at least one driven gear having said output diameter to define said second gear stage for selectively moving the output shaft with the first output; and
wherein said pin is disposed within each of said second gear pockets when said second selected gear is disposed in said cavity, with said first gear section having said second diameter engaged with said drive gear having said input diameter to define said first gear stage, and with said second gear section having said fourth diameter engaged with said at least one driven gear having said output diameter to define said second gear stage for selectively moving the output shaft with the second output.

22. A method of manufacturing a gear drive assembly for use with and driven by a motor in an actuator, with the actuator capable of moving an output shaft between a plurality of positions, with the actuator having one of a first output, having a first velocity and a first torque, and a second output, having a second velocity and a second torque, with the gear drive assembly comprising a housing having an internal surface defining a cavity, and a gear arrangement disposed in the cavity and comprising a drive gear, at least one driven gear, and one of a first selected gear and a second selected gear, wherein the drive and the at least one driven gears and the first selected gear have a first gear ratio for selectively moving the output shaft with the first output, and the drive and the at least one driven gears and the second selected gear have a second gear ratio not equal to the first gear ratio for selectively moving the output shaft with the second output; said method comprising the steps of:
rotatably coupling the drive and the at least one driven gears with the housing within the cavity;
selecting one of the first and second selected gears;
engaging the one of the first and second selected gears with both of the drive and the at least one driven gears; and
rotatably coupling the one of the first and second selected gears with the housing within the cavity.

23. The method as set forth in claim 22, wherein the internal surface of the housing defines a first gear retention feature to facilitate selective rotatable coupling of the first selected gear with the housing and a second gear retention feature to facilitate selective rotatable coupling of the second selected gear with the housing, and wherein the step of rotatably coupling the one of the first and second selected gears with the housing is further defined as the step of rotatably coupling the one of the first and second selected gears with a respective one of the first and second gear retention features.

24. The method as set forth in claim 23, wherein each of said first and second selected gears define a hole extending therethrough, and said internal surface of said housing defines a pair of first gear pockets as said first gear retention feature and a pair of second gear pockets as said second gear retention feature, wherein said step of rotatably coupling the one of the first and second selected gears with a respective one of the first and second gear retention features is further defined as the steps of inserting a pin through the hole of the one of the first and second selected gears and inserting the pin into a respective one of the pair of first gear pockets and the pair of second gear pockets.

25. The method as set forth in claim 22 wherein the at least one driven gear includes one of a first selected first driven gear engageable with the first selected gear and a second selected first driven gear engageable with the second selected gear to transmit rotation from the drive gear to one of the first and second selected first driven gear, the method further including the step of selecting one of the first and second selected first driven gears corresponding with the selected one of the first and second selected gears.

26. The method as set forth in claim 25 wherein the step of engaging the one of the first and second selected gears with both of the drive and the at least one driven gears is further defined as engaging the one of the first and second selected gears with both of the drive and the respective one of the first and second selected first driven gears.
